(19) United States
(12) Patent Application Publication
(10) Pub. No.: US 2019/0210905 A1
(43) Pub. Date: Jul. 11, 2019

(54) DOSAGE OPTIMIZATION METHOD OF CHEMICAL CONDITIONER FOR DEEP DEWATERING OF SLUDGE

(71) Applicant: HUAZHONG UNIVERSITY OF SCIENCE AND TECHNOLOGY, Hubei (CN)

(72) Inventors: Jiakuan YANG, Hubei (CN); Wenbo YU, Hubei (CN); Shuangyi TAO, Hubei (CN); Sha LIANG, Hubei (CN); Yafei SHI, Hubei (CN); Jingping HU, Hubei (CN); Huijie HOU, Hubei (CN); Ruonan GUAN, Hubei (CN); Yang LV, Hubei (CN); Hongsen LI, Hubei (CN); Jiangwei YU, Hubei (CN); Shaogang HU, Hubei (CN)

(73) Assignee: HUAZHONG UNIVERSITY OF SCIENCE AND TECHNOLOGY, Hubei (CN)

(21) Appl. No.: 16/326,922

(22) PCT Filed: Jan. 19, 2017
(86) PCT No.: PCT/CN2017/071691

§ 371 Date: Feb. 21, 2019

(30) Foreign Application Priority Data
Dec. 29, 2016 (CN) 201611244154.0

(51) Int. Cl. C02F 11/06; C02F 11/145; C02F 11/122; C02F 1/00

(52) U.S. Cl. CPC C02F 11/06; C02F 11/145; C02F 2101/30; C02F 1/008; C02F 2305/026; C02F 11/122

(57) ABSTRACT

The present invention discloses a dosage optimization method of a chemical conditioner for deeply dewatering the sludge in a municipal wastewater treatment plant, comprises the following steps: (1) optimizing a dosage of a chemical conditioner added into a specific sludge to obtain an optimal dosage proportion of the chemical conditioner corresponding to unit mass of organic matter; (2) calculating an optimal dosage of the chemical conditioner applicable for other sludge to be treated; and (3) adding the chemical conditioner into the sludge to be treated for sludge conditioning treatment, and then performing mechanical dewatering treatment, so as to obtain a deeply dewatered sludge with a moisture content of less than 60%. By improving the reference basis as the key chemical conditioner dosage, the method can effectively solve the problem that types and moisture content range of sludge to which the chemical conditioner dosage control method is applicable are narrow.

### BACKGROUND OF THE INVENTION

### 1. Technical Field

The present invention belongs to the technical field of sludge pretreatment of municipal wastewater treatment plants (WWTPs), and more particularly relates to a dosage optimization method of a chemical conditioner for deep dewatering of the sludge. In this optimization method, optimization and control on the dosage of the chemical conditioner for destroying organic floc structure of the sludge are performed to deeply dewater the sludge (i.e., the dewatered sludge has a moisture content of less than 60%). This optimization method is suitable for treatment and disposal of the municipal sludge, and is suitable for treatment of deep dewatering and reduction of the front sludge.

### 2. Description of the Related Art

The so-called municipal sludge is a general term for the primary sludge and excess sludge produced in the activated sludge process in a municipal wastewater treatment plant. The municipal sludge mainly contains various pathogens and microorganisms, oxygen-consuming pollutants, plant fibers, heavy metals, general organic substances, and inorganic pollutants such as acids, alkalis and salts. Since the municipal sludge contains a high content of organic matter, the sludge floc contains a large amount of extracellular polymeric substances (EPS) with strong hydrophilicity, resulting in high content of bound water, which makes it difficult to separate sludge flocs and water. According to the statistics in 2013, about 83% of the sludge in China's municipal wastewater treatment plants has not been effectively disposed. The sludge has high moisture content, large volume, large change in organic matter content and difficult deep dewatering of the sludge, which are the bottlenecks of the sludge treatment and disposal. At present, in the municipal wastewater treatment plants, the sludge is generally conditioned by using polymeric flocculants (such as PAM), and then dewatered by a high-speed centrifuge or a belt filter press, in which way only sludge cake with a moisture content of about 80% can be obtained. This is difficult to meet the index requirement (sludge moisture content ≤60%) for co-landfilling in “the disposal of sludge from municipal wastewater treatment plant—quality of sludge for co-landfilling” (GB/T 23485-2009). Therefore, it is necessary to carry out deep dewatering of the sludge (the moisture content of the sludge is reduced to 60% or less), so that the dewatered sludge cake meets the requirement of subsequent treatment and disposal.

Water in the municipal sludge generally consists of 70% free water and 30% bound water (including capillary water, particle internal water and adsorbed water). There are many factors influencing the improvement of sludge dewatering efficiency, in which a large amount of hydrophilic sludge floc structures (including a large amount of bound water) formed by sludge EPS is an important reason for difficult sludge dewatering. The EPS, which is the main component of the sludge organic matter, can adsorb and absorb water by selective absorption, functional group ionization and the like, and thus exhibits a highly hydrophilic effect, which is detrimental to sludge dewatering. Meanwhile, the high organic matter content of the sludge is also an important factor restricting the degree of sludge dewatering. Since the organic matter is easily compressed and deformed under the action of mechanical high pressure, pores of the filter cake may be blocked at the later stage of filtration, that is, the water filtration passages are blocked, resulting in low dewatering efficiency at present. The general physical conditioning is difficult to solve the problem of the removal of void water and capillary water, and has disadvantages of high operating cost, large equipment investment and the like. To achieve deep dewatering, it is necessary to destroy the charged floc matrix of the highly hydrophilic group of the sludge and improve the compression performance of the floc, so that the bound water contained in the sludge floc grid can be released to the maximum extent to be effectively removed by mechanical pressure filtration. Chemical conditioning is a relatively economical and practical conditioning method for deep dewatering of sludge.

At present, dosages of chemical conditioners for the sludge are mostly controlled based on sludge dry basis (mg/g DS, or % DS) (for example, Chinese Patent Application Publication No. CN 104649533 A discloses a chemical conditioner dosing method in which dosages of free radical generating substance, sulfide and industrial byproduct gypsum are respectively 1 to 10%, 1 to 10% and 10 to 40% in sludge dry basis weight, and U.S. Pat. No. 4,587,022 A discloses that the dosage of the dry dewatering additive is at least 10% in sludge dry basis weight). In another commonly used dosage control method of chemical conditioners for the sludge, dosages are determined with sludge volume (% by volume, or mg/L) as the measurement unit (for example, Chinese Patent Application Publication No. CN 105800909 A discloses that dosages of a concentration reagent A, a concentration reagent B and a concentration reagent C are each 1.0-10.0% (by volume) of the total amount of sludge, and U.S. Pat. No. 6,368,511 B1 discloses that dosages of Fe²⁺ and H₂O₂ are respectively 1.125 to 6% and 1.5 to 8% (percentage by volume) of the total amount of sludge). The above-mentioned conventional chemical conditioner dosing methods based on sludge dry basis (mg/g DS, or % DS) and sludge volume (mg/L) have certain applicability to conventional sludge treatment processes involving only free water removal from sludge, such as sludge sedimentation process, concentration process, sludge centrifugal dewatering and belt pressure filtration process. However, these methods have poor applicability to the deep dewatering process involving the removal of bound water that is tightly combined with organic macromolecules of EPS.

According to monitoring data, the organic matter content of sludge is closely related to factors such as sludge source, season and rainfall, and varies greatly. The organic matter content of sludge in the same wastewater treatment plant (or WWTPs) varies from 20% to 50% in different seasons, and the organic matter contents of sludges generated in different wastewater treatment plants also vary greatly due to different influent water quality and processes. The conditioner dosing methods based on sludge dry basis (mg/g DS) and sludge volume (mg/L) in the existing patents and recommended literatures have a poor deep dewatering effect on the sludge with high organic matter content, and for sludge that is easily dewatered with low organic matter content, dosages of chemical conditioners are excessive, resulting in waste of the conditioners. The EPS content, which is an important factor affecting the dewatering performance, in the sludge is an important component of the organic matter content of the sludge, and since the organic matter content in the sludge has a significant effect on the bound water, general dosage control methods of chemical conditioners for the sludge cannot be adapted to the change in quality of sludges with different organic matter contents. In optimum formulations obtained by chemical conditioner dosing methods based on sludge dry basis or sludge volume, the dosage of the chemical conditioner does not change with the change of the organic matter content of the sludge, resulting in poor adaptability of the traditional chemical conditioner dosing methods to sludges with different organic matter contents. In particular, for a given goal (such as 60 wt %) of the moisture content of the deeply dewatered sludge cake, when common chemical conditioner dosing methods based on sludge dry basis (mg/g DS, or % DS) are used for sludge with higher organic matter content, the designed goal of the moisture content of the sludge cake may not be achieved, and when they are used for sludge with lower organic matter content, the chemical conditioner may be excessively dosed. Otherwise, it is necessary to carry out an optimization experiment method such as orthogonal design to develop an optimization formula for each sludge with different quality, which will cost a lot of labor and materials.

In 2015, Jialin Liang et al. found a significant linear relationship between bound water content and organic matter content in the sludge (R²=0.9701, as shown in FIG. 2), and this result was published in Water Research 84 (2015), 243-254. During the deep dewatering of the sludge, how to change the existence state of bound water in the sludge, how to destroy the hydrophilic floc structure of the sludge EPS and how to solve the problem of the adaptability of the chemical conditioner to different sludge quality are breakthroughs to further increase the sludge dewatering degree. Therefore, there is currently an urgent need for a chemical conditioner dosing formula optimized by a chemical conditioner dosing method to adapt to excess sludges with different organic matter contents, ensuring that the dewatering performance of the conditioned sludge can not only achieve a predetermined deep dewatering goal (the moisture content of the dewatered sludge is less than 60%), but also avoid waste of the chemical conditioner and increase in cost resulting from excessive dosages of the chemical conditioner.

### SUMMARY OF THE INVENTION

In view of the above-described defects or improvement requirements in the art, the present invention provides a dosage optimization method of a chemical conditioner for deeply dewatering the sludge. Compared with the prior art, this method can effectively solve, by improving the reference basis as the key chemical conditioner dosage, the problem that type and moisture content range of the sludge to which the chemical conditioner dosage control method is applicable are narrow. The method of the present invention can be effectively adapted to sludges with different qualities, and has a good guiding effect on the engineering practice of deep dewatering of sludges with different characteristics.

In order to achieve the above objective, according to the present invention, there is provided a dosage optimization method of a chemical conditioner for deep dewatering of the sludge, characterized in that, comprising following steps of:

(1) through a response surface method or an orthogonal test method, with respect to a specific sludge, performing optimization on a dosage of a chemical conditioner added into the specific sludge by taking an organic matter content of the specific sludge as a reference to obtain an optimal dosage of the chemical conditioner when the specific sludge has an optimal dewatering effect, so as to obtain an optimal dosage proportion of the chemical conditioner corresponding to unit mass of organic matter;

(2) according to the optimal dosage proportion of the chemical conditioner corresponding to unit mass of organic matter obtained in the step (1), calculating an optimal dosage of the chemical conditioner applicable for other sludge to be treated, such that an optimal dosage proportion of the chemical conditioner corresponding to unit mass of organic matter for the sludge to be treated is in correspondence with the optimal dosage proportion of the chemical conditioner corresponding to unit mass of organic matter obtained in the step (1);

(3) according to the optimal dosage of the chemical conditioner applicable for the sludge to be treated calculated in the step (2), adding the chemical conditioner in the sludge to be treated for sludge conditioning treatment, and then performing mechanical dewatering treatment, so as to obtain a deeply dewatered sludge with a moisture content of less than 60%.

Preferably, the chemical conditioner is a composite conditioner composed of oxidation reagent and skeleton builder; the oxidation reagent in the chemical conditioner includes at least one of Fenton reagent, persulfate conditioner, permanganate and zero-valent iron conditioner; and the skeleton builder in the chemical conditioner includes at least one of lime, fly ash, diatomaceous earth, phosphogypsum and cement.

Further preferably, in the step (1), an organic matter content of the specific sludge is 20 to 70%.

In general, by comparing the above technical solution of the present inventive concept with the prior art, this optimization method can be effectively adapted to sludges with different qualities, and has a good guiding effect on the engineering practice of deep dewatering of sludges with different characteristics, since the dosage of the chemical conditioner is optimized based on the organic matter content of the sludge to be treated.

In the wastewater treatment plant, due to fluctuation in quality of the influent water in the wastewater treatment plant, different wastewater treatment processes, seasonal climate changes and the like, the quality of the sludge varies greatly. Generally, chemical conditioner dosage control methods of the sludge include a chemical conditioner dosage method based on sludge volume (percentage % by volume, or mg/L), which cannot control the conditioning effect due to large fluctuation in sludge moisture content, and a chemical conditioner dosage method based on sludge dry basis (mg/g DS, or % DS), which cannot control the conditioning effect due to due to large fluctuation in organic matter content in the sludge. In deep dewatering of sludge in the present invention, a conditioner dosage method based on sludge organic matter content (for example, mg/g organic matter, that is, a dosage proportion of the chemical conditioner corresponding to unit mass of organic matter is controlled) is adopted, which can be effectively adapted to sludges with different qualities and has a good guiding effect on the engineering practice of deep dewatering of sludges with different characteristics. The method has simple steps, and strong adaptability to change in sludge quality since the chemical conditioner dosage is determined based on sludge organic matter content, and thus, the method can improve the utilization rate of the chemical conditioner, save cost, and is suitable for large-scale promotion.

The difficulty of the present invention lies in the need of sludges with different organic matter contents as research objects to carry out experimental research in this aspect, and although researchers have found that sludge organic matter content has a great influence on the sludge dewatering effect, no specific solutions and countermeasures have been proposed. Due to the fact that the results of dewatering sludges with different organic matter contents by optimizing the conditioner dosage based on sludge dry basis, moisture contents of the dewatered sludge cakes vary greatly, which is difficult to meet the requirements of reagent conditioning and stability of deep dewatering effect, the present invention proposes that sludge organic matter content basis is used as the optimization reference object to optimize sludge conditioner dosage, and with respect to the conditioner dosage optimization and dewatering experiments for different sludges, a well-adapted conditioner dosage optimization and control method for conditioning and deep dewatering of sludge is obtained.

The present invention provides a dosage (mg/g organic matter) optimization and control method of a conditioner for deeply dewatering the sludge based on unit mass organic matter according to the key factor affecting sludge conditioning: organic matter content. This breaks through the traditional conditioning methods based on sludge volume (mg/L, or percentage % by volume) and sludge dry basis (mg/g DS, or % DS). The chemical conditioner for deeply dewatering the sludge used in this method is a composite conditioner composed of oxidation reagent and skeleton builder. The oxidation reagent in the chemical conditioner is one of Fenton reagent, persulfate conditioner, permanganate, zero-valent iron conditioner and the like or a combination thereof, and the principle is that strong oxidizing groups or oxidizing groups such as free radicals are generated to destroy the sludge floc so as to release water. The skeleton builder in the chemical conditioner is a reagent with inorganic matter as the main component, including lime, fly ash, diatomaceous earth, phosphogypsum, cement and the like. In this method, by matching the dosage of the chemical conditioner for the sludge with the organic matter content in the sludge, the utilization efficiency of the chemical conditioner can be greatly improved, and thus, this method has good adaptability to sludges with different qualities, and can be well applied to engineering practice of deep dewatering and reduction of sludges of different sources.

In the optimization method and dosage control method of the chemical conditioner for deeply dewatering the sludge in the present invention, the dosage of the chemical conditioner for the sludge is calculated based on the organic matter content in the sludge. The optimization formula obtained by the dosage optimization method of the chemical conditioner has good universality for sludges with different organic contents. In addition, compared with the traditional conditioner dosage methods based on sludge dry basis (mg/g DS, or % DS) and sludge volume (percentage % by volume, or mg/L), the conditioner dosage optimization method based on sludge organic matter content is simpler. There is no need to carry out a formula optimization experiment such as an orthogonal design experiment on each sludge with different quality, which will save a lot of labor and material costs. This method lays the foundation for the engineering practice of deep dewatering of the sludge.

In the dosage optimization method of the chemical conditioner for deeply dewatering the sludge in the present invention, deep dewatering of the sludge is performed after conditioning with the chemical conditioner, and the dosage of the chemical conditioner for destroying the organic floc structure of the sludge to deeply dewatering the sludge is optimized based on the organic matter content of the sludge, thereby achieving the following two effects:

(1) the optimization method is adapted to sludges with different organic matter contents, thereby overcoming the limitation that traditional optimization methods based on sludge dry basis (mg/g DS, or % DS) and sludge volume (percentage % by volume, or mg/L) have good conditioning effect on only a specific sludge.

(2) the composite conditioner composed of oxidation reagent and skeleton builder can be used as a cell breaking reagent to maintain pH of the filtrate of dewatered sludges with different qualities to be 6 to 7, so that the filtrate can be directly refluxed to a biological tank of the wastewater plant or used as a carbon source to strengthen the process of nitrogen and phosphorus removal from wastewater to avoid secondary pollution, while avoiding corrosion of pipes and equipment; meanwhile, the skeleton builder can improve the compressibility of the sludge cake, maintain the flow path of the filtered water, and improve the dewatering efficiency. In addition, the dosage optimization method of the chemical conditioner for deeply dewatering the sludge has a simple process, greatly improves the utilization rate of the conditioner, reduces a large amount of conditioner dosage optimization work, and thus can achieve effective disposal of sludge in deep dewatering.

### BRIEF DESCRIPTION OF THE DRAWINGS

FIG. 1 is a schematic diagram showing the binding form of water in the sludge; and

FIG. 2 is a diagram showing a relationship between organic matter content (VSS/TSS) and bound water content in the sludge.

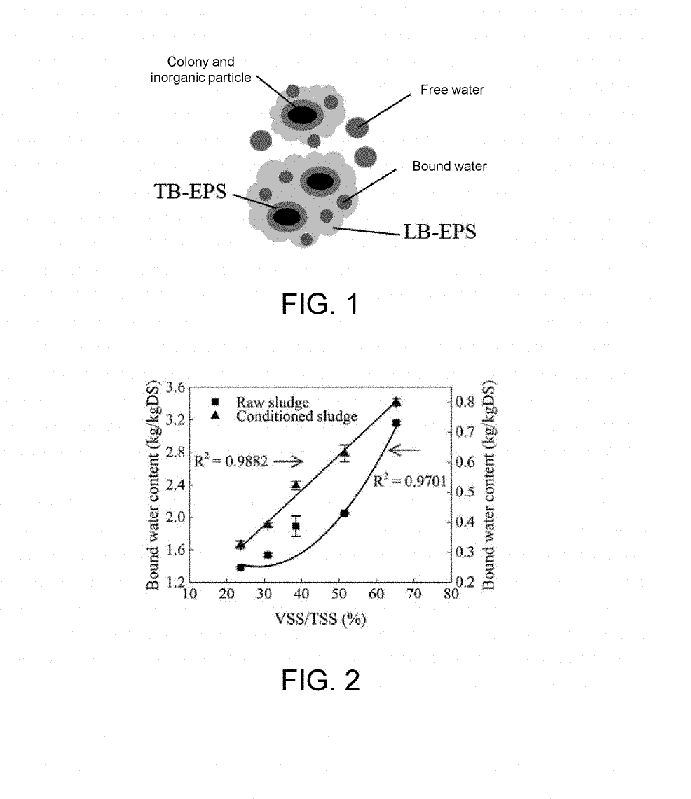

### DETAILED DESCRIPTION OF THE EMBODIMENTS

For clear understanding of the objectives, features and advantages of the present invention, detailed description of the present invention will be given below in conjunction with accompanying drawings and specific embodiments. It should be noted that the embodiments described herein are only meant to explain the present invention, and not to limit the scope of the present invention. Furthermore, the technical features related to the embodiments of the invention described below can be mutually combined if they are not found to be mutually exclusive.

According to embodiments of the present invention, there is provided a dosage optimization and control method of a chemical conditioner for deeply dewatering the sludge based on sludge organic matter content. The dosage of the chemical conditioner optimized by the method is matched with the organic matter content of the sludge, and the chemical conditioner can fully destroy the EPS structure of the sludge floc, thereby releasing the bound water and reducing the compressibility of the organic matter. Thus, this method has good adaptability to sludges with different volatile component contents. The dosage optimization and control method of cell-breaking reagents for deeply dewatering the sludge comprises the following steps:

S1: through the response surface method, the orthogonal test method and other optimization methods, performing, with respect to a specific sludge with a moderate organic matter content, optimization on the dosage of the chemical conditioner in units of milligrams per gram (mg/g organic matter mass), that is, conditioner dosage per unit mass of organic matter, so as to obtain a dosage optimization formula of the chemical conditioner for a certain sludge;

S2: according to the dosage optimization formula obtained in step S1, calculating the organic matter content of the sludge with a different organic matter content to obtain a dosage optimization formula of the chemical conditioner suitable for the sludge with such an organic matter content; and

S3: performing dosage control by using the dosage optimization formula of the chemical conditioner based on organic matter content, sludge conditioning and mechanical dewatering treatment to obtain a deeply dewatered sludge with a moisture content of less than 60%.

Specifically, in the above step S1, the sludge may be selected from municipal sludges with different properties at different times and different places. In order to make the result optimized in the step S1 more representative, a municipal sludge with an organic matter content of about 40% is preferably selected as an experimental object for conditioner dosage optimization.

In the step S1, the chemical conditioner for deep dewatering of the sludge is a composite conditioner composed of oxidation reagent and skeleton builder, in which the oxidation reagent is one of Fenton reagent, persulfate conditioner, permanganate, zero-valent iron conditioner and the like or a combination thereof, and the skeleton builder is a reagent with inorganic matter as the main component, including lime, fly ash, diatomaceous earth, phosphogypsum, cement and the like.

In the embodiments of the present invention, a composite conditioner composed of oxidation reagent and skeleton builder is used to perform conditioner dosage optimization treatment based on sludge organic matter content, achieving the following two effects:

(1) the optimization method is adapted to sludges with different organic matter contents, thereby overcoming the limitation that traditional optimization methods based on sludge dry basis (mg/g DS, or % DS) and sludge volume (percentage % by volume, or mg/L) have good conditioning effect on only a specific sludge.

(2) the composite conditioner composed of oxidation reagent and skeleton builder can be used as a cell breaking reagent to maintain pH of the dewatered filtrate of sludges with different qualities to be 6 to 7, so that the filtrate can be directly refluxed to a biological tank of the wastewater plant or used as a carbon source to strengthen the process of nitrogen and phosphorus removal from wastewater to avoid secondary pollution, while avoiding corrosion of pipes and equipment; meanwhile, the skeleton builder can improve the compressibility of the sludge cake, maintain the flow path of the filtrate, and improve the dewatering efficiency. In addition, the dosage optimization method of the chemical conditioner for deeply dewatering the sludge has a simple process, greatly improves the utilization rate of the conditioner, reduces a large amount of conditioner dosage optimization work, and thus can achieve effective disposal of the sludge in deep dewatering.

The present invention will now be further described in detail by taking the conditioner dosage optimization process and control method based on sludge organic matter content as an example, in which a composite conditioner composed of oxidation reagent and skeleton builder is used as a chemical conditioner for deeply dewatering the sludge.

### Embodiment 1

In this embodiment, effects of a conditioner dosage control method based on sludge organic matter content and a conditioner dosage method based on sludge dry basis are compared, and the steps are as follows:

S1: a municipal sludge with a moderate organic matter content was selected as an object. The organic matter content of the municipal sludge in Wuhan city is about 20% to 60%, and a municipal sludge with an organic matter content of 44% was representatively selected. Through the response surface method, with respect to a sludge with a specific organic matter content, optimization on dosages of three components (wherein two are oxidation reagents, and one is a skeleton builder) of the composite conditioner composed of oxidation reagent and skeleton builder in units of milligrams per gram (mg/g organic matter mass) was performed to obtain a conditioner dosage optimization formula for this sludge: dosages of a cell breaking reagent A1, a cell breaking reagent B1 and a skeleton reagent C1 are 106.91, 86.16 and 110.00, respectively (mg/g organic matter mass);

S2: according to the optimization formula obtained in the step S1, with respect to a sludge with a different organic matter content, the dosage of the conditioner was calculated based on sludge organic matter content to obtain a composite conditioner optimization formula for the sludge with the organic matter content.

In this embodiment, sludges with different organic matter contents were taken from four different wastewater treatment plants (WWTP) for verification test. The organic matter contents of the sludges from these wastewater treatment plants are 25.6%, 41.20%, 49.67% and 59.83%, respectively.

Dosages of the conditioner calculated based on different sludge organic matter masses are shown in Table 1 below:

TABLE 1

| | | | | Conditioner dosage calculated | | |
|---|---|---|---|---|---|---|
| | | | Organic | based on organic matter | | |
| | Organic | Sludge | matter | Cell | | |
| | matter | dry | mass in | breaking | | Skeleton |
| | content | basis | sludge | reagent | Reagent | reagent |
| Source | (%) | (kg) | (kg) | A1 (g) | B1 (g) | C1 (g) |
| WWTP1 | 25.60 | 0.7 | 0.18 | 19.24 | 15.51 | 20 |
| WWTP2 | 41.20 | 0.7 | 0.29 | 31.00 | 24.99 | 32 |
| WWTP3 | 49.67 | 0.7 | 0.35 | 37.42 | 30.16 | 38 |
| WWTP4 | 59.83 | 0.7 | 0.42 | 44.90 | 36.19 | 46 |

At the same time, in order to make a comparison with the conditioner dosage control method based on sludge dry basis (mg/g DS), the conditioner was added according to the optimization formula based on sludge dry basis in combination with the result optimized in the step S1. Dosages of the conditioner calculated based on sludge dry basis are shown in Table 2 below:

TABLE 2

| | | | | Conditioner dosage calculated | | |
|---|---|---|---|---|---|---|
| | | | Organic | based on DS | | |
| | Organic | Sludge | matter | Cell | | |
| | matter | dry | mass in | breaking | | Skeleton |
| | content | basis | sludge | reagent | Reagent | reagent |
| Source | (%) | (kg) | (kg) | A1 (g) | B1 (g) | C1 (g) |
| WWTP1 | 25.60 | 0.7 | 0.18 | 32.93 | 26.54 | 34 |
| WWTP2 | 41.20 | 0.7 | 0.29 | 32.93 | 26.54 | 34 |
| WWTP3 | 49.67 | 0.7 | 0.35 | 32.93 | 26.54 | 34 |
| WWTP4 | 59.83 | 0.7 | 0.42 | 32.93 | 26.54 | 34 |

S3: sludge dewatering treatment: after the two conditioner dosage methods were respectively used to perform sludge conditioning, mechanical dewatering treatment was performed (filtration pressure: 0.8 MPa, diaphragm pressing pressure: 1.2 MPa).

The tests showed that after the conditioned sludges were dewatered by plate-frame pressure filtration, moisture contents of the sludge cakes obtained by the two conditioner dosage methods are shown in Table 3 below:

TABLE 3

| | Organic | Moisture content of dewatered sludge cake (%) | |
|---|---|---|---|
| | matter | Method based on sludge | Method based on |
| Source | content (%) | organic matter content | sludge dry basis (DS) |
| WWTP1 | 25.60% | 44.27 | 45.23 |
| WWTP2 | 41.20% | 51.80 | 52.54 |
| WWTP3 | 49.67% | 56.31 | 58.22 |
| WWTP4 | 59.83% | 59.71 | 63.02 |

It is obvious from the above results that the optimization method of the present invention adopting the composite conditioner composed of oxidation reagent and skeleton builder can be well adapted to sludges with different organic matter contents. With the optimization method, the sludge dewatering effect can be obviously improved for a sludge with high organic matter content, and for a sludge with low organic matter content, the dewatering effect equivalent to that of the traditional dosage method is ensured while greatly reducing dosages of reagents.

### Embodiment 2

In this embodiment, the adaptability of the optimization formula, which is obtained by the conditioner dosage control method based on sludge organic matter content, to sludges with different organic matter contents is verified, and steps are as follows:

S1: through the response surface method, with respect to a sludge with an organic matter content of 42.8%, dosage optimization of the composite conditioner composed of oxidation reagent and skeleton builder was performed to obtain a composite conditioner dosage optimization formula based on unit mass of organic matter for this sludge: dosages of a cell breaking reagent A2 is 271 (mg/g organic matter mass), a cell breaking reagent B2 is 49 (mg/g organic matter mass), and a skeleton reagent C2 is 935 (mg/g organic matter mass);

S2: similarly, through the response surface method, with respect to a sludge with an organic matter content of 49.8%, dosage optimization of the composite conditioner was performed to obtain a composite conditioner dosage optimization formula based on unit mass of organic matter for this sludge: dosages of a cell breaking reagent A2 is 269 (mg/g organic matter mass), a cell breaking reagent B2 is 49 (mg/g organic matter mass), and a skeleton reagent C2 is 872 (mg/g organic matter mass).

It is obvious from the above results that compared with the cases where the traditional optimization methods based on sludge dry basis (mg/g DS) and sludge volume (percentage % by volume, or mg/L) have great difference in optimal results of dosages of the conditioner for different sludges, optimal dosages of the composite conditioner composed of oxidation reagent and skeleton builder optimized by the method of the present invention are very close, regardless of sludge organic matter content, indicating that the method of the present invention can be well adapted to sludges with different organic matter contents.

### Embodiment 3

In this embodiment, with respect to the composite conditioner for deeply dewatering different sludges, the conditioner dosage control method based on unit mass of organic matter is verified, and steps are as follows:

S1: a municipal sludge with moderate organic matter content was selected as an object, and in this embodiment, a municipal sludge with an organic matter content of 53.73% was representatively selected. Through the response surface method, with respect to a sludge with a organic matter content of 53.73%, optimization on the dosage of the composite conditioner composed of oxidation reagent and skeleton builder in units of milligrams per gram (mg/g organic matter mass) was performed to obtain an dosage optimization formula of the three components of the composite conditioner for deeply dewatering this sludge: dosages of a cell breaking reagent A3, a cell breaking reagent B3 and a skeleton reagent C3 are 100.15 (mg/g organic matter mass), 123.00 (mg/g organic matter mass), and 650.00 (mg/g organic matter mass), respectively;

S2: according to the optimization formula obtained in the step S1, with respect to a sludge with a different organic matter content, the dosage of the conditioner was calculated based on unit mass of organic matter to obtain a composite conditioner optimization formula for deeply dewatering the sludge with the organic matter content.

Sludges with different organic matter contents in different wastewater treatment plants can be tested, and in this embodiment, a sludge with an organic matter content of 46.14% is selected for testing.

The dosage of the conditioner calculated based on sludge organic matter content is shown in Table 4 below:

TABLE 4

| | | | | Conditioner dosage calculated | | |
|---|---|---|---|---|---|---|
| | | | Organic | based on organic matter content | | |
| | Organic | Sludge | matter | Cell | | |
| | matter | dry | mass in | breaking | | Skeleton |
| | content | basis | sludge | reagent | Reagent | reagent |
| Source | (%) | (kg) | (kg) | A3 (g) | B3 (g) | C3 (g) |
| WWTPa | 46.14 | 0.4 | 0.18 | 18.027 | 22.14 | 117 |

At the same time, in order to make a comparison with the conditioner dosage method based on sludge dry basis (mg/g DS), the conditioner was added according to the optimization formula based on sludge dry basis in combination with the result optimized in the step S1. The dosage of the conditioner calculated based on sludge dry basis is shown in Table 5 below:

TABLE 5

| | | | | Conditioner dosage calculated | | |
|---|---|---|---|---|---|---|
| | | | Organic | based on DS | | |
| | Organic | Sludge | matter | Cell | | |
| | matter | dry | mass in | breaking | | Skeleton |
| | content | basis | sludge | reagent | Reagent | reagent |
| Source | (%) | (kg) | (kg) | A3 (g) | B3 (g) | C3 (g) |
| WWTPa | 46.14 | 0.4 | 0.18 | 21.524 | 26.435 | 139.70 |

S3: sludge dewatering treatment: after the two conditioner dosage methods were respectively used to perform sludge conditioning, mechanical dewatering treatment was performed (filtration pressure: 0.8 MPa, diaphragm pressing pressure: 1.2 MPa).

The tests showed that after the conditioned sludges were dewatered by plate-frame pressure filtration, moisture contents of the sludge cakes obtained by the two conditioner dosage methods are shown in Table 6 below:

TABLE 6

| | Organic | | |
|---|---|---|---|
| | matter | Moisture content of deeply dewatered sludge cake (%) | |
| | content | Method based on sludge | Method based on sludge |
| Source | (%) | organic matter content | dry basis (DS) |
| WWTPa | 46.14% | 52.53 | 53.41. |

It is obvious from the above results that the optimization method of the present invention adopting the composite conditioner composed of oxidation reagent and skeleton builder can be well adapted to sludges with different organic matter contents. For the raw sludge with the same quality, the sludge dewatering effect can be obviously improved for a sludge with high organic matter content, and for a sludge with low organic matter content, the dewatering effect equivalent to that of the traditional dosage method is ensured, while greatly reducing dosages of reagents.

In the actual project, the optimization of the deep dewatering conditioner for destroying the organic floc structure of the sludge only needs to be performed for a representative sludge, and then optimal dosages of the conditioner adapted for different sludges can be calculated according to volatile component contents of the different sludges, which results in greatly saved number and cost of optimization experiments, simple operation and good effect, and lays the foundation for the engineering practice of deep dewatering of the sludge.

The optimization methods such as the response surface method and the orthogonal test method in the present invention can be directly referred to the related prior art, for example, the literature published by Tony et al. in Chemosphere 2008, 72, (4), 673-677.

In a dosage optimization method of a chemical conditioner for deeply dewatering the sludge in the present invention, the optimal dosage of the chemical conditioner is calculated based on the organic matter content of the sludge to be treated, and the organic matter content can be measured according to the standard method in solid waste determination of organic matter in national environmental protection standards HJ 761-2015.

It should be readily understood to those skilled in the art that the above description is only preferred embodiments of the present invention, and does not limit the scope of the present invention. Any change, equivalent substitution and modification made without departing from the spirit and scope of the present invention should be included within the scope of the protection of the present invention.

1. A dosage optimization method of a chemical conditioner for dewatering sludge, comprising following steps of:
(1) through a response surface method or an orthogonal test method, with respect to a specific sludge, performing optimization on a dosage of a chemical conditioner added into the specific sludge by taking an organic matter content of the specific sludge as a reference to obtain an optimal dosage of the chemical conditioner when the specific sludge has an optimal dewatering effect, so as to obtain an optimal dosage proportion of the chemical conditioner corresponding to unit mass of organic matter; the organic matter content of the specific sludge is 20 to 70%;
(2) according to the optimal dosage proportion of the chemical conditioner corresponding to unit mass of organic matter obtained in the step (1), calculating an optimal dosage of the chemical conditioner applicable for other sludge to be treated, such that an optimal dosage proportion of the chemical conditioner corresponding to unit mass of organic matter for the sludge to be treated is in correspondence with the optimal dosage proportion of the chemical conditioner corresponding to unit mass of organic matter obtained in the step (1), the sludge to be treated is a municipal sludge; and
(3) according to the optimal dosage of the chemical conditioner applicable for the sludge to be treated calculated in the step (2), adding the chemical conditioner to the sludge to be treated for sludge conditioning treatment, and then performing mechanical dewatering treatment, so as to obtain a deeply dewatered sludge with a moisture content of less than 60%, wherein the chemical conditioner is a composite conditioner composed of oxidation reagent and skeleton builder; the oxidation reagent in the chemical conditioner includes at least one of Fenton reagent, persulfate conditioner, permanganate and zero-valent iron conditioner for generating oxidizing groups to destroy sludge flocs to be treated so as to release the bound water; and the skeleton builder in the chemical conditioner includes at least one of lime, fly ash, diatomaceous earth, phosphogypsum and cement; the composite conditioner includes three components, two of which are oxidation reagents and one of which is a skeleton builder; dosages of the two oxidation reagents are respectively 100.15 to 271 mg/g organic matter and 49 to 123 mg/g organic matter, and a dosage of the skeleton builder is 110 to 935 mg/g organic matter.

2. (canceled)

3. (canceled)
